(19) United States
(12) Patent Application Publication
(10) Pub. No.: US 2025/0024856 A1
(43) Pub. Date: Jan. 23, 2025

(54) MEALWORM SPREAD

(71) Applicant: ECODELYS, Boucherville (CA)

(72) Inventors: Marc Lacroix, Ste-Julie (CA); Charles Emond, Sainte-Anne-de-la-Pocatière (CA)

(21) Appl. No.: 18/775,261

(22) Filed: Jul. 17, 2024

Related U.S. Application Data
(60) Provisional application No. 63/527,196, filed on Jul. 17, 2023.

(51) Int. Cl. A23J 3/04; A23J 1/00; A23J 3/22; A23L 33/17

(52) U.S. Cl. CPC A23J 3/04; A23J 1/00; A23J 3/227; A23L 33/17

(57) ABSTRACT

A mealworm larvae protein spread is prepared by reheating blanched larvae. A pulp and a first separated liquid fraction produced by placing the reheated blanched larvae in a juice extractor are then separated. The pulp is mixed with boiling water, creating a diluted pulp. The diluted pulp is pulverized, preferably using a high shear mixer, until it acquires a homogeneous texture and color. A second extraction is performed producing a second separated liquid fraction. The first separated liquid fraction and the second separated liquid fraction are combined, producing the mealworm larvae protein juice which may then be cooked with butter, egg yolks and dry ingredients to produce the mealworm larvae protein spread.

### BACKGROUND

### (A) Field

The subject matter disclosed generally relates to a delicious spread made of mealworm larvae that is a source of complete proteins, ecological and without involving animal suffering.

### (b) Related Prior Art

There is a trend in society worldwide to eat without harming animals. This trend is referred to as “veganism” or “plant-based” food. Vegans envision a world in which all people agree that all animals (human and non-human) are or may be sentient beings who are subjectively aware of, and able to value their own lives. Accordingly, animals should not be treated as property and that every form of exploitation of, or harm to, animals is considered morally wrong. The underlying principle of veganism is that everyone must respect and cooperatively protect the rights of animals, perceive and treat their similar needs and interests as equal, and enable them to live their lives without being exploited by humans.

It is a known fact that after eating solely plant-based foods, one shows the sign of animal protein deficiencies which includes moderate to severe physiological symptoms such as fatigue, constant hunger, muscle weakness, ligament fragility, weakened immune system, slower healing, loss of hair and brittles nails, sleeping disorder, difficulty in concentrating, edema, gastrointestinal tract disorders, weight loss, delayed or stopped growth in children, loss in muscle mass, and mental disorders.

It would be highly desirable to be provided with a source of animal protein that would not cause any harm to animals.

### SUMMARY

According to an embodiment, there is provided a spread made of mealworm larvae that is a source of complete proteins, ecological and without involving animal suffering.

According to another embodiment, there is provided a process to prepare a mealworm larvae protein juice used in the preparation of the mealworm larvae spread.

According to yet another embodiment, there is provided a method for preparing the mealworm larvae protein spread.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 illustrates the mealworm larvae.

FIG. 2 illustrates the prior art terrine or spread prepared from animal liver.

FIG. 3 illustrates the present invention spread prepared with mealworm larvae.

### DETAILED DESCRIPTION

In embodiments there is disclosed a cooked emulsion of blanched mealworm larvae, liquid and/or starch and/or proteins which provide a texture and a taste similar to meat pates, mousses and terrines as well as similar protein content. In the present description, the term mealworm larvae is also referenced by its scientific name Tenebrio molitor.

The liquid can typically be water and/or wine and/or beer and/or cream and/or milk. Milk can be reconstituted milk, that is obtained by combining powdered milk (whole or skimmed) or buttermilk with water. The starch can typically be potato starch, pea starch, rice flour, corn starch and/or tapioca starch. The proteins can typically be yellow pea protein, faba bean protein, soy protein product, whey protein concentrate powder, rennet casein, sodium caseinate, and/or milk powder. The liquid can also be another source of proteins such as milk.

This emulsion can be made in different flavors by adding specific aromatic ingredients, not limited to, such as garlic, pink pepper, truffle oil and alcoholic liquor such as Grand Marnier.

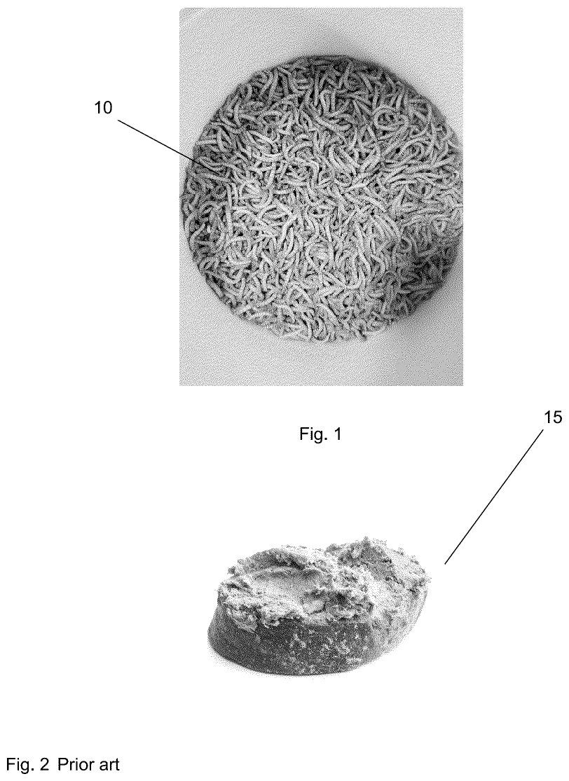

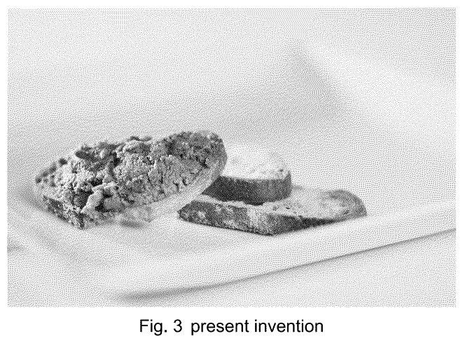

FIG. 1 shows a picture of mealworm larvae 10, also known by its scientific name as Tenebrio molitor. FIG. 2 shows a spread of the prior art prepared with animal liver. FIG. 3 shows the spread 15 of the present invention.

The present invention will be more readily understood by referring to the following examples which are given to illustrate the invention rather than to limit its scope.

### Example 1

### Process of Preparation of the Mealworm Larvae Protein Spread

The first step in preparing the mealworm larvae protein spread 15 is preparing the mealworm larvae protein juice made from the mealworm larvae 10. This mealworm larvae protein juice is prepared as follows:
a) first, the blanched mealworm larvae 10, placed in a vacuum bag, must be reheated until they reach an internal temperature of at least 70° C. (158° F.);
b) then, extracting a pulp and a first separated liquid fraction from the larvae. A juice extractor, preferably but not limited to, of a type using two screws and equipped with a fine sieve, may be used. The pulp is separated from the liquid after the extraction, the sieve being adapted to collect the pulp. The first separated liquid is set aside.
c) then, the pulp is mixed with boiling water, the quantity of boiling water having a mass between 30% and 70%, preferably 50% of a mass of larvae initially heated in a). This creates a diluted pulp;
d) then, the diluted pulp is pulverized, preferably using a high shear mixer, until it acquires a homogeneous texture and color;
e) then, a second extraction is performed, extracting a solid and a second separated liquid fraction from the diluted pulp. Again, the juice extractor may be used and sifting the remaining larvae shells may be performed; and
f) finally, the first and second separated liquid fractions are combined, thereby producing the mealworm larvae protein juice.

Once the mealworm larvae protein juice is ready, the next step is to prepare the mealworm larvae protein spread 15. The method for preparing the mealworm larvae protein spread 15 is as follows:
a) first, the mealworm larvae protein juice is combined with a liquid additive in a cooking vessel. The cooking vessel may have heating walls. The liquid additive may be, without limitation, water, wine, beer, cream and/or milk;
b) then, dry ingredients are added to the content of the cooking vessel. The dry ingredients may be, without limitation, a protein source, such as a soy protein product, a whey protein concentrate powder, rennet casein, sodium caseinate, milk powder, yellow pea protein or faba bean protein; a starch such as pea starch, rice flour, tapioca starch, corn starch and potato starch; a gelling agent such as alginate, pectin, carrageenan, gelatin, gellan and agar; a flavoring additive such as salt, garlic powder, onion powder, spices, natural flavor, pepper, pink pepper; and a food coloring such as caramel food coloring, annatto, curcuma and/or cochineal;
c) then, the content of the cooking vessel is heated;
d) then, optionally butter and at least one egg yolk or egg are incorporated to the content of the cooking vessel r when the content reaches 30° C. (86° F.); and
e) finally, the content is stirred to a smooth consistence. Care should be taken to minimize addition of air to the content while stirring.

Then, if a sterilized product is desired, the following steps may be followed:
a) heating the content to a temperature ranging from 60° C. to 85° C. placing the content in a jar designed for sterilization such as a Dominion & Grimm no. 706558503177 container; and
c) sterilizing in an autoclave the closeable container in order to obtain a lethal value (FO value) of at least 3.5.

Then, if a pascalized product is desired, the following steps may be followed:
a) heating the content to a temperature of about 72° C.
b) placing the content in a flexible container typically made of plastic and cardboard; and
c) high pressure processing (HPP) for 180 sec at 6000 bars.

### Example 2

### Process of Preparation of the Mealworm Larvae Protein Spread

1. Production of Tenebrio molitor Liquid Base
1.1 Heat the mealworm larvae 10 placed in a packaging (such as a vacuum bag) to an internal temperature of at least 70° C. This serves the purpose of liquefying as much as possible the fat of the Tenebrio molitor, which is rather saturated;
1.2. Weigh the quantity of larvae;
1.3. Transfer to a juice extractor (for example, GreenStarPro's 2-gears grinder-type juicer), assembled with its finest sieve;
1.4 Perform a first sieve pass;
1.5. Collect the pulp and the first separated liquid fraction separately;
1.6. Mix the pulp obtained with between 30% and 70%, preferably 50% of the mass of Tenebrio molitor initially added at step 1.2 of very hot/boiling water. For example: for 1000 g (2.2 lbs) of larvae initially used, mix the pulp with 500 g (1.1 lbs) of boiling water. This produces the second separated liquid fraction;
1.7. Pulverize with an immersion blender until a homogeneous color and texture is obtained.
1.8. Transfer to the juice extractor;
1.9. Combine the first and the second separated liquid fractions;
1.10. Optional: Sieve to remove excess exoskeletons.
   2. Assembling the Spread into Terrines
2.1. Prepare dry ingredients: protein source, such as a soy protein product, a whey protein concentrate powder, yellow beans or dry beans; a starch such as tapioca starch, corn starch and potato starch; a gelling agent such as agar; a flavoring additive such as salt, garlic powder, spices, caramelized onion flavor, pepper, pink pepper; and a food coloring such as caramel food coloring;
2.2. Melt the butter;
2.3. Prepare egg yolks by separating the yolks;
2.4. Combine the liquid base of Tenebrio molitorwith the milk in a double jacketed mixing tank equipped with a surface scraper;
2.5. Incorporate dry ingredients;
2.6. When temperature reaches 30° C. (86° F.), stir in the melted butter and egg yolks. This allows keeping the butter in a liquid state and avoids cooking the yolks immediately upon incorporating them;
2.7. Stir vigorously to obtain a smooth texture without incorporating air;
2.8. Continue heating to between 60° C. and 85° C. to gelatinize the starch without cooking the other ingredients;
2.9. Place the spread in jars. For example, 150 g (0.33 lb) of spread may be placed in a 229 ml (0.95 cup) cylindrical glass jar (for example, a 70 mm (2.75 in) diameter, ‘Lug’ threaded, #reference Dominion & Grimm 706558503177);
2.10. Attach the lid (#reference Dominion & Grimm 706558593086);
2.11. Sterilize in an autoclave to obtain a lethal factor (FO value) of at least 3.5 with at either 5, 10 and 15 psi and adjusting the time accordingly:

Table of ingredients

| | % content |
|---|---|
| Tenebrio molitor liquid base | 54.16% |
| Whole milk (3.25% fat) | 19.26% |
| Egg yolks | 7.93% |
| pea protein isolates | 7.66% |
| Unsalted butter | 6.34% |
| Tapioca starch | 1.32% |
| Salt | 1.32% |
| Spice mix | 1.19% |
| Agar | 0.26% |
| Natural coloring | 0.20% |
| Natural flavor | 0.35% |

While preferred embodiments have been described above and illustrated in the accompanying drawings, it will be evident to those skilled in the art that modifications may be made without departing from this disclosure. Such modifications are considered as possible variants comprised in the scope of the disclosure.

1. A process to prepare a mealworm larvae protein juice, which comprises the steps of:
a. reheat the larvae until the larvae reach an internal temperature between 60° C. and 85° C.;
b. extracting a pulp and a first separated liquid fraction from the larvae.

2. The process of claim 1, further comprising the steps of:
a. mixing the pulp to boiling water, the boiling water having a mass between 30% and 70% of a mass of larvae initially heated in a), thereby creating a diluted pulp;
b. pulverizing the diluted pulp until it acquires a homogeneous texture and color;
c. extracting a solid and a second separated liquid fraction from the diluted pulp; and
d. combining the first separated liquid fraction to the second separated liquid fraction thereby producing the mealworm larvae protein juice.

3. The process of claim 1 or 2, wherein the extracting is done using a juice extractor preferably of a type using two screws equipped with a fine sieve, the sieve being adapted to collect the pulp.

4. The process of claim 1 or 2, wherein the pulverizing comprises using a high shear mixer.

5. The process of claim 1 or 2, further comprising sieving after step e) to remove remaining larvae shells.

6. A method for preparing a mealworm larvae protein spread comprising:
a) combining the mealworm larvae protein juice of any one of claims 1 to 6 with a liquid additive in a cooking vessel to create a content;
b) adding dry ingredients to the content of the cooking vessel;
c) heating the content of the cooking vessel;
d) incorporating butter and at least one egg yolk to the content of the cooking vessel; and
e) stirring the content to smooth the content of the cooking vessel without adding air to the content.

7. The method of claim 7 further comprising:
a) heating the content to a temperature ranging from preferably between 60° C. to 85° C.
b) placing the content in a jar designed for sterilization; and
c) sterilizing in an autoclave the jar to obtain a lethal factor (FO value) of at least 3.5 at either 5, 10 and 15 psi and adjusting the time accordingly.
or
a) heating the content to a temperature of about 72° C.
b) placing the content in a flexible container typically made of plastic and cardboard; and
c) pasteurizing under high pressure (HPP).

8. The method of claim 8 wherein the dry ingredients comprise at least one of:
a protein source selected from the group consisting of a soy protein product, a whey protein concentrate powder, yellow pea protein and faba beans protein, rennet casein, sodium caseinate, and/or milk powder;
a starch selected from the group consisting of pea starch, rice flour, tapioca starch, corn starch and potato starch;
a gelling agent selected from the group consisting of alginate, pectin, carrageenan, gelatin, gellan and agar; and
a flavoring additive selected from the group consisting of salt, garlic powder, onion powder, spices, natural flavor, pepper, pink pepper, rosemary, and fine herbs.

9. The method of claim 9 wherein the liquid additive is at least one of water, wine, beer, cream and milk.

10. A mealworm larvae protein spread made from the method of any one of claims 7 to 10.

11. The mealworm larvae protein spread of claim 11, further comprising at least one of yellow beans, dry beans, tapioca starch, corn starch, potato starch, salt, garlic powder, spices, natural flavor, pepper, pink pepper, agar and food coloring.
